(19) United States
(12) Patent Application Publication
(10) Pub. No.: US 2019/0277119 A1
(43) Pub. Date: Sep. 12, 2019

(54) Flow Control System and Method

(71) Applicant: Starstream Limited, Beverley (GB)

(72) Inventor: Jonathan Campion, Beverley (GB)

(73) Assignee: Starstream Limited, Beverley (GB)

(21) Appl. No.: 16/302,476

(22) PCT Filed: Jun. 9, 2017
(86) PCT No.: PCT/GB2017/051691

§ 371 Date: Nov. 16, 2018

(30) Foreign Application Priority Data
Jun. 17, 2016 (GB) 1610581.9

(51) Int. Cl. E21B 43/12; E21B 43/40; G05D 7/06

(52) U.S. Cl. CPC E21B 43/122; G05D 7/0652; E21B 43/40

(57) ABSTRACT

A system (20) for controlling gas flow allocation to gas-lifted wells, the system comprising: a gas lift manifold (3) for receiving pressurised gas at an in-flow rate x_{T}, the gas lift manifold being in fluid communication with n continuous gas lifted wells via respective flow control valves (5) to distribute the gas to each well at individual out flow rates x₁, x₂, . . . xₙ through each flow control valve wherein in a state of equilibrium the in-flow rate x_{T} equals the sum of the individual out flow rates: x_{T}=x₁+x₂ . . . +xₙ and wherein the system comprises a controller apparatus (27) in operative communication with the flow control valves, the controller apparatus being configured to determine and set an individual out flow rate x₁, x₂, . . . xₙ at each respective flow control valve for a given total amount of the available in-flow rate x_{T}.

### FIELD OF THE INVENTION

The present invention relates generally to a system for and a method of controlling flow, and more specifically, to controlling and optimising gas flow allocation to gas-lifted oil wells.

### BACKGROUND TO THE INVENTION

Gas lift is a commonly used method of artificial lift which uses high-pressure gas for supplementing formation gas to lift the well fluids. The principle of gas lift is that gas, injected into the tubing reduces the density of the fluids in the tubing, and the bubbles have a “scrubbing” action on the liquids. Both factors act to lower the flowing BHP (bottom-hole pressure) at the bottom of the tubing.

The vast majority of gas lift wells are produced by continuous flow, which is very similar to natural flow. In continuous flow gas-lift, the formation gas is supplemented with additional high-pressure gas. Gas is injected continuously into the production conduit at depth. The injection gas mixes with the produced well fluid and decreases the density and, subsequently, the flowing pressure gradient of the mixture from the point of gas injection to the surface. The decreased flowing pressure gradient reduces the flowing bottom-hole pressure to below the static bottom-hole pressure thereby creating a pressure differential that allows the fluid to flow into the wellbore and produce to the surface. At a certain point however, the benefit of increased production due to decreased static head pressure is overcome by the increase in frictional pressure loss from the large gas quantity present. This has the effect of increasing the BHP and lowering fluid production. This effect is shown in FIG. 1.

A reliable, adequate supply of good quality high-pressure lift gas is required. This supply is necessary throughout the producing life of the well if gas lift is to be maintained effectively. As fields mature, the greater demand for lift gas in conjunction with limitations imposed by existing facilities and prevailing operating conditions (compressor capacity, lift gas availability, wells shut-in for workover, water cut increases etc.) can prevent optimal production from being achieved, and an outside source of injection gas is required.

FIG. 2 describes a typical configuration in industry. Gas compressors 1 deliver high pressure gas to a gas lift manifold 3. The gas lift manifold 3 is relieved into each continuous gas lifted well (not shown). Each flow control valve 5 is manually set at a position by the control room operator to best achieve the desired flow. The position of the flow control valve 5 is an output from a flow controller 7. The flow controller 7 usually manifests as digital PID (Proportional, Integral and Derivative) controller. To set the position of the flow control valve 5, the control room operator sets the mode of the flow controller 7 to manual and sets the output to a fixed value. From plant start-up the gas flow to each well is slowly manually increased until a coarsely optimised amount is settled at. Without an external source, the gas lift process requires produced hydrocarbon gas to be re-injected to sustain and increase the overall gas flow. FIG. 3 shows such a gas flow circuit.

FIG. 3 shows a system 10 in which gas injected into gas-lifted wells 12 is obtained from the gas produced from those wells 12. Produced fluid is delivered to a separator 14 in which gas and liquids are separated and distributed to their respective manifolds. Gas compressed by the compressor 1 is delivered to a gas lift manifold 3. The gas lift manifold 3 is relieved into the annulus 16 of each gas lifted well 12 via respective flow control valves 5. Gas lift valves 18 inject the gas into the production conduit 19 where the gas mixes with the formation fluid. The more oil is produced from a gas-lifted well 12, the more gas is produced. The system 10 needs to be controlled so that gas is best distributed all the time allowing more oil and associated additional gas to be produced thereby sustaining its own injection supply and reaching the highest possible total flow rate. As gas lift well production declines the amount of gas flow to the compressor 1 reduces. Typically, the existing method of operation seen regularly in industry uses injection flow control valves which are manually set to control the amount of gas injected to the multiple gas lifted wells. The reduced amount of gas being produced from the gas lifted wells may not be enough to sustain a steady flow and thus pressure to the gas lift injection manifold.

Typically, the position of each gas injection flow control valve 5 is manually set by the control room operator to obtain a predetermined flow. The control room operator manually adjusts the flow control valve 5 on each well 12 so that the gas injection flow rate measured by a flow transmitter 9 (see FIG. 2) matches the pre-defined flow desired.

The predetermined flow values for each gas-lifted well 12 are usually calculated by an engineer offline based on the historic total amount of gas flow available and the productivity of each gas lifted well. The assumed total amount of gas available used by the engineer will be a conservative figure based on the troughs from historic flow trends. Applying this fixed figure effectively bottlenecks the potential total gas flow and introduces inefficiencies typical of manual optimisation.

Where the flow control valves 5 are manually controlled, regular adjustment by the control room operator to maintain gas lift manifold pressure is required during process changes. In this situation, if the flow control valves 5 were set to automatic control (with the predetermined flow values being the controller set-points) decreases in compressor 1 forward flow (because of process conditions) would manifest as decreases in gas lift manifold pressure. Decreases in gas lift manifold pressure risk automatically shutting down the gas lift process. As the gas lift manifold pressure fluctuates, the amount of gas being injected fluctuates because it is a function of the flow control valve 5 position and the differential pressure across the flow control valve 5. All this means that steady and efficient delivery of injection gas is difficult to achieve when operating the gas lift process with manually positioned or individually flow controlled valves 5.

As shown in FIGS. 2 and 3, lift gas is sometimes supplied to multiple gas lifted wells 12. In situations where the amount of gas available for injection is limited, the peak gas injection rate being delivered to each and every well 12 may not be possible. Therefore optimum distribution of injection gas to each well 12 will mean that the operating point (gas injection flow rate) will be somewhere on the curve (see FIG. 1) prior to the peak.

The restricted optimum injection rate for multiple gas lifted wells with differing curves can be shown to be where the tangents are parallel on each of the curves. FIG. 4 shows the gas injection rate versus oil production rate of two typical gas lifted wells. The difference in curves is governed by the physical characteristics of the well completion amongst many other things. The tangents have been positioned to show the restricted optimum distribution of 3000 cubic meters per hour of gas available for injection between the two wells. The range of oil production rate varied by different gas injection distribution between the two wells is shown in FIG. 5. The operating point in FIG. 5 is representative of the two tangents shown on FIG. 4.

Because of repeated ongoing control room operator intervention of the injection flow control valve positions and the gas lift manifold pressure fluctuations, achieving the maximum oil and gas flow rate is difficult if not impossible to achieve manually. Automatic individual flow control is also difficult to achieve in this scenario because the gas injection manifold inflow, and thus pressure, will vary with process conditions.

Because the amount of gas available for injection depends on the amount of gas produced from the gas lifted wells, it is important that the gas is injected efficiently. If the gas is not delivered steadily and distributed efficiently between the gas-lifted wells, the peak gas flow potential will not be reached. Oil and gas production in this case is therefore limited and sub-optimal.

The present invention seeks to mitigate and/or obviate the drawbacks of the prior art.

### SUMMARY OF THE INVENTION

According to a first aspect of the present invention there is provided a system for controlling gas flow allocation to gas-lifted wells, the system comprising:
a gas lift manifold for receiving pressurised gas at an in-flow rate x_{T}, the gas lift manifold being in fluid communication with TI continuous gas lifted wells via respective flow control valves to distribute the gas to each well at individual out flow rates x₁, x₂, . . . xₙ through each flow control valve wherein in a state of equilibrium the in-flow rate x_{T} equals the sum of the individual out flow rates:

x_{T}=x₁+x₂ . . . +xₙ
and
wherein the system comprises a controller apparatus in operative communication with the flow control valves, the controller apparatus being configured to determine and set an individual out flow rate x₁, x₂, . . . xₙ at each respective flow control valve for a given total amount of the available in-flow rate x_{T} in accordance with the formula:

$${x}_{n} = {S}_{n} {x}_{T} + {I}_{n}$$

$$wherein$$

$${S}_{n} = \frac{{b}_{n}}{( {b}_{1} + {b}_{2} + {b}_{n} )}$$

$$wherein$$

$${I}_{n} = \frac{{b}_{n} ( {b}_{1} ln ( \frac{{b}_{1}}{{a}_{1}} ) + {b}_{2} ln ( \frac{{b}_{2}}{{a}_{2}} ) + {b}_{n} ln ( \frac{{b}_{n}}{{a}_{n}} ) - ( {c}_{1} + {c}_{2} + {c}_{n} ) )}{( {b}_{1} + {b}_{2} + {b}_{n} )} - {b}_{n} ln ( \frac{{b}_{n}}{{a}_{n}} ) + {c}_{n}$$

wherein
a is the maximum production flow rate from the respective well;
b is defined as one fifth of the associated individual gas injection rate in the respective well at which peak production flow is achieved;
c is individual gas injection rate required in the respective well before production flow starts in the well.

In some variants, c is assumed to be zero.

Preferably, the gas injection manifold includes a master pressure controller upstream of the flow control valves, the master pressure controller being in operative communication with the controller apparatus, and the master pressure controller operating at an output rate uₘ(t) wherein the output rate uₘ(t) of the master pressure controller is equal to the total in-flow rate x_{T} in a state of equilibrium:

uₘ(t)=x_{T}

The controller apparatus is preferably configured to determine and set an individual out flow rate x₁, x₂, . . . xₙ at each flow control valve in accordance with the output rate uₘ(i) of the master pressure controller.

The master pressure controller may be a digital PID (Proportional, Integral and Derivative) controller. Gas injection manifold pressure is preferably measured by a pressure transmitter. The master pressure controller preferably operates at a gas injection manifold pressure value Pₘₐₙ equal to the master pressure controller set-point r.

Preferably, the controller apparatus is adapted to operate in real time.

Preferably, the controller apparatus comprises a programmable electronic processor.

In one embodiment, the controller apparatus is located remotely from the master pressure controller and the flow control valves. Preferably, the flow control valves are variable position flow valves and more preferably, the flow control valves are located on the platform top sides (as opposed to being located downhole or subsea). Preferably, all of the gas compressors, gas lift manifold, flow control valves and the controller apparatus of the system are located on the platform top sides.

Preferably, gas flow in each flow control valve is controlled by a respective flow controller. The flow controller may be a digital PID controller. The gas injection flow rate via each flow control valve is preferably measured by a respective flow transmitter.

The system is preferably a reinjection system in which gas produced from the wells is reinjected into the gas lift manifold for use in gas lifting. In this configuration, the system preferably includes a separator for separating gas from production fluid and one or more compressors for pressuring the gas in the gas injection manifold.

Preferably, the controller apparatus is adapted to continuously adjust all flows through the respective flow control valves for all wells for any amount of gas available. This has the effect of producing more oil and more gas to be reinjected into the gas injection manifold. Over a period of gas recirculation the total flow will increase to a new equilibrium.

The invention utilises a master pressure controller of which the output value represents the total amount of gas available for injection to the gas-lifted wells. The pressure controller output value is used in real time calculation to determine the optimum gas injection flow rate to each well. The calculation uses pre-set values which represent an exponential curve approximation of the productivity curve of each gas lifted well.

The present invention controls the gas injection manifold pressure by modulating the gas injection flow control valves in an optimum manner.

The invention provides a system for and a method of automatically controlling gas injection flow rates from a limited source to multiple continuous gas lifted wells in order to achieve the optimum oil and gas production from an oil field. Controlled allocation and distribution of lift gas in accordance with the invention maximizes total oil production from a field with continuously gas lifted oil wells. Limitations in gas flow supply capacity mean all wells cannot produce the peak oil rate. In this case the available gas needs to be distributed in such a way that oil production is maximized. The invention provides a remote, real time automatic control method which takes into account the oil production versus gas injection characteristics of each well. The invention, amongst other benefits, increases gas flow and oil production.

According to a second aspect of the present invention there is provided a method for controlling gas flow allocation to gas-lifted wells, the method comprising:
delivering pressurised gas into a gas lift manifold at an in-flow rate x_{T}, the gas lift manifold being in fluid communication with n continuous gas lifted wells via respective flow control valves
distributing the gas to each well at individual out flow rates x₁, x₂, . . . xₙ through each respective flow control valve wherein in a state of equilibrium the in-flow rate x_{T} equals the sum of the individual out flow rates:

x_{T}=x₁+x₂ . . . +xₙ
and
determining and setting an individual out flow rate x₁, x₂, . . . xₙ at each respective flow control valve for a given total amount of the available in-flow rate x_{T} in accordance with the formula:

$${x}_{n} = {S}_{n} {x}_{T} + {I}_{n}$$

$$wherein$$

$${S}_{n} = \frac{{b}_{n}}{( {b}_{1} + {b}_{2} + {b}_{n} )}$$

$$wherein$$

$${I}_{n} = \frac{{b}_{n} ( {b}_{1} ln ( \frac{{b}_{1}}{{a}_{1}} ) + {b}_{2} ln ( \frac{{b}_{2}}{{a}_{2}} ) + {b}_{n} ln ( \frac{{b}_{n}}{{a}_{n}} ) - ( {c}_{1} + {c}_{2} + {c}_{n} ) )}{( {b}_{1} + {b}_{2} + {b}_{n} )} - {b}_{n} ln ( \frac{{b}_{n}}{{a}_{n}} ) + {c}_{n}$$

wherein
a is the maximum production flow rate from the respective well;
b is defined as one fifth of the associated individual gas injection rate in the respective well at which peak production flow is achieved;
c is individual gas injection rate required in the respective well before production flow starts in the well.

The method preferably comprises providing a controller apparatus in operative communication with the flow control valves and using the controller apparatus to determine and set an individual out flow rate x₁, x₂, . . . xₙ at each respective flow control valve for a given total amount of the available in-flow rate x_{T} in accordance with the formula:

xₙ=Sₙx_{T}+Iₙ

In some variants, the method includes assuming c to be zero.

Preferably, the method comprises the step of controlling gas pressure in the gas injection manifold by a master pressure controller provided upstream of the flow control valves, the master pressure controller being in operative communication with the controller apparatus, and the master pressure controller operating at an output rate uₘ(t) wherein the output rate uₘ(t) of the master pressure controller is equal to the total in-flow rate x_{T} in a state of equilibrium:

uₘ(t)=x_{T}

Preferably, the method comprises the step of determining and setting an individual out flow rate x₁, x₂, . . . xₙ at each flow control valve in accordance with the output rate uₘ(t) of the master pressure controller.

The master pressure controller may be a digital PID controller. The method may include measuring gas injection manifold pressure by a pressure transmitter. The method may include operating the master pressure controller at a gas injection manifold pressure value Pₘₐₙ equal to the master pressure controller set-point r.

Preferably, the method comprises the step of determining and setting an individual out flow rate x₁, x₂, . . . xₙ at each respective flow control valve in real time.

In one embodiment, the method includes the step of providing the controller apparatus remote from the master pressure controller and the flow control valves.

Preferably, the method comprises the step of controlling gas flow in each flow control valve by a respective flow controller. The flow controller may be a digital PID controller. The method may include measuring the gas injection flow rate via each flow control valve by a respective flow transmitter.

The method preferably includes reinjecting gas produced from the wells into the gas injection manifold for use in gas lifting. In this configuration, the method preferably involves using a separator for separating gas from production fluid and one or more compressors for pressuring the gas in the gas injection manifold.

Preferably, the method comprises continuously adjusting all flows through the respective flow control valves for all wells for any amount of gas available.

Features of the first aspect of the invention can be incorporated into the second aspect of the invention and vice versa, as appropriate.

### BRIEF DESCRIPTION OF THE DRAWINGS

Embodiments of the present invention will now be described, by way of example only, with reference to the following drawings, in which:

FIG. 1 illustrates correlation between gas-lift injection rate and production rate in a prior art multi well gas lift system;

FIG. 2 is a schematic illustration of a portion of a prior art multi well gas-lift system showing gas compressors and multiple flow control valves;

FIG. 3 is a schematic illustration of a prior art multi well gas-lift system;

FIG. 4 illustrates correlation between gas-lift injection rate and production rate and a restricted optimal injection rate for two wells in prior art;

FIG. 5 illustrates total production over different gas injection distributions in a prior art system; and

FIG. 6 is a schematic illustration of an embodiment of a multi well gas-lift system in accordance with the present invention.

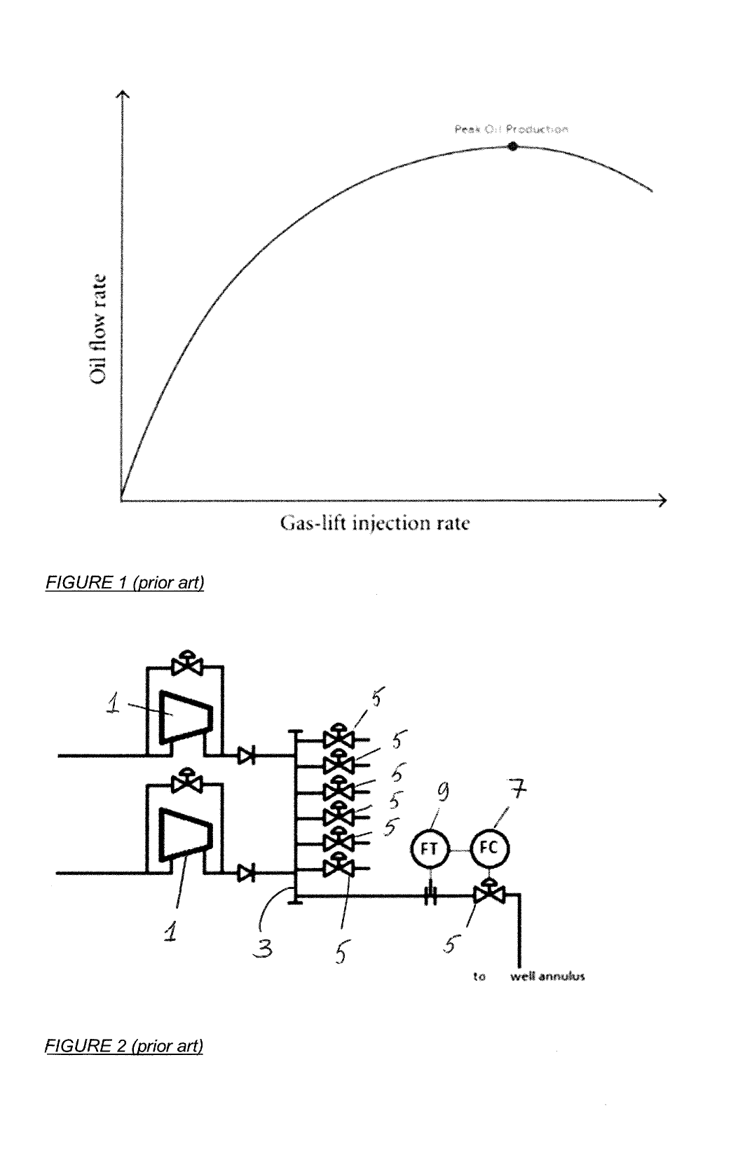

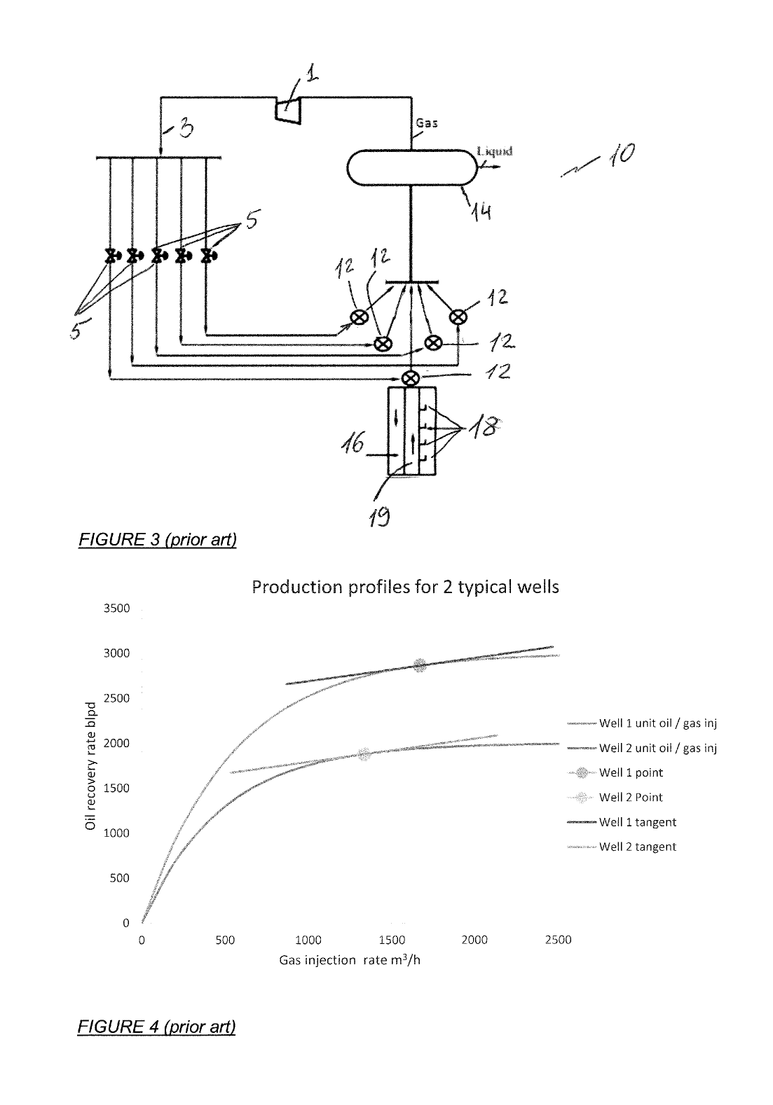

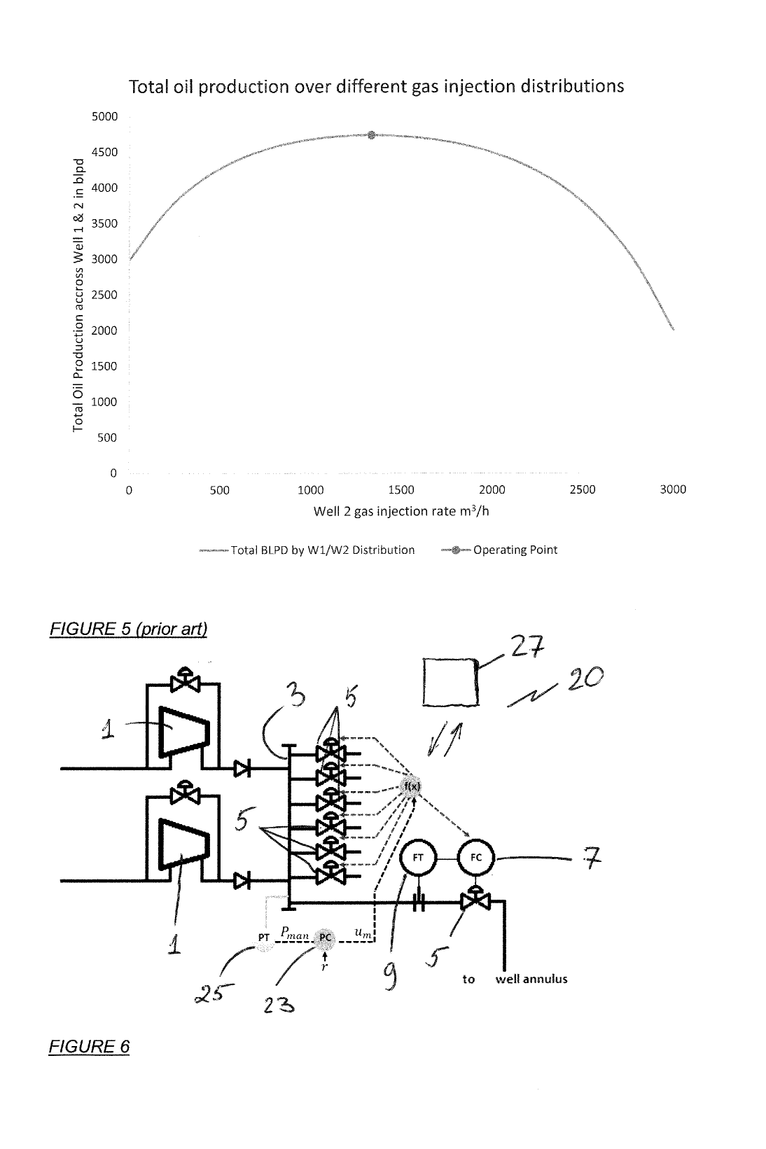

Referring to FIG. 6, flow control system 20 and method in accordance with the invention will be jointly described. For brevity, elements of the system 20 of the invention common with the prior art system of FIGS. 2 and 3 have been denoted using common reference numerals. The system 20 forms part of a gas lift circuit, such as, for example, one shown in FIG. 3.

In the system 20, gas compressors 1 deliver high pressure gas to a gas lift manifold 3. The gas lift manifold 3 is relieved into each continuous gas lifted well (not shown) via flow control valves 5. Each flow control valve 5 of the system 20 in accordance with the present invention is preferably a variable position flow control valve 5 which can be set at a number, and more preferably an infinite number, of positions between fully open and fully closed positions as well as the fully open and fully closed positions. The position of the variable position flow control valve 5 is controlled by an output from a flow controller 7. The flow controller 7 may be a digital PID (Proportional, Integral and Derivative) controller. The gas injection flow rate may be measured by a flow transmitter 9.

The gas injection manifold 3 receives an in-flow rate of gas x_{T} from the compressor 1. The total out-flow rate from the gas injection manifold 3 is the sum of the individual out-flow rates through each well's injection flow control valve 5, i.e. x₁+x₂ . . . +xₙ for n gas lifted wells. In a state of equilibrium the in-flow rate equals the total out-flow rate where for n gas lifted wells:

x_{T}=x₁+x₂ . . . +xₙ Equation 1

Assuming the gas is an ideal gas with a steady state temperature, in this state the pressure Pₘₐₙ of the gas within the gas injection manifold 3 is constant. This is shown by expressing the ideal gas equation:

$${P}_{man} = \frac{RT}{{V}_{man} M} m \qquad Equation 2$$

Where Vₘₐₙ is a fixed volume representing the volume of the gas injection manifold 3, m is the mass of gas contained within Vₘₐₙ, M is the constant molar mass of the gas composition, R is the universal gas constant, and T is the temperature of the injection gas. Assuming gas flow rates x_{T}, x₁, x₂, . . . , xₙ are mass flow rates the manifold gas pressure is constant when:

$$\frac{{dP}_{man}}{dt} = \frac{RT}{{V}_{man} M} [ {x}_{T} - ( {x}_{1} + {x}_{2 } … + {x}_{n} ) ] = 0 \qquad Equation 3$$

The gas injection manifold 3 includes a master pressure controller 23, which may be a digital PID controller. Gas injection manifold pressure may be measured by a pressure transmitter 25. The pressure controller 23 operates in automatic control with a measured value Pₘₐₙ (gas injection manifold pressure) equal to the pressure controller set-point r. In a state of equilibrium, the output uₘ(t) of the pressure controller 23 would be equal to x_{T}. Using an ideal pressure controller algorithm:

$${u}_{m} ( t ) = {K}_{mp} ( {e}_{m} ( t ) + \frac{1}{{T}_{mi}} {\int }_{0}^{t} {e}_{m} ( t ) dt + {T}_{md} \frac{{de}_{m} ( t )}{dt} ) \qquad Equation 4$$

Where the error eₘ is:

eₘ=r−Pₘₐₙ Equation 5

Kₘₚ is the pressure controller gain, Tₘᵢ is the pressure controller integral action time,

T_{md} is the pressure controller derivative action. uₘ(t) is equal to x_{T} in steady state.

The equation for calculating individual gas injection flow remote set points is derived from manipulating exponential approximations of each individual gas lift curve. By ignoring the part of the gas lift curve where gas injection rate has increased past peak oil production rate the gas lift curve can be approximated by the exponential function:

$$y = a ( 1 - {e}^{- ( \frac{x - c}{b} )} ) \qquad Equation 6$$

where y is the individual well oil production rate and x is the individual well gas injection rate. a defines the peak (maximum) oil flow rate from the well. When x is five times b, it approximates to when y is within 1% of a. a simply scales the value at which settles out at as x increases (assuming b is a constant), i.e. as

$${e}^{- ( \frac{x - c}{b} )}$$

tends to zero. b is defined as one fifth of the associated individual gas injection rate at which peak oil production is achieved, i.e.:

$$b = \frac{x where \frac{dy}{dx} = 0 on the lift curve}{5} \qquad Equation 7$$

c is the gas rate required before oil will start to flow (assumed to be zero in the examples below). b in the equation described above is equivalent to the time constant τ in equations characterising response to a step input of a first-order, linear time-invariant (LTI) system. This is the reason why b is defined as one fifth of the x value of the peak of the curve. In LTI systems the 1% settling time (time required to be within 1% of the steady-state value) is approximately 5 τ.

It is possible to approximate using this type of exponential function because it can be assumed that any values of x (gas injection flow rate) more than x at dy/dx=0 (maximum liquids flow rate) are irrelevant when using these curves to calculate efficiency. In other words, if total peak gas flow is constrained, there is no desire to inject a gas flow rate that would exceed the amount required for peak liquids production for any one well.

This exponential function approximation of the real gas lift curve closely fits because the actual mathematical representation of a gas lift system can be reasonably approximated to a simple linear system at the associated operating points. Careful selection of a, b and c ensure that the approximation has very similar dy/dx at proposed operating points.

The advantage gained by using this type of approximation is that manipulating the mathematics to solve the ideal injection rates for multiple wells for any x_{T} total available gas becomes possible without iterative slope finding methods not usually employed in remote and/or online control systems. As described above, the restricted optimum injection rate x₁, x₂, . . . , xₙ for multiple gas lifted wells with differing curves can be shown to be where the tangents of those curves are parallel. The tangents are parallel when dyₙ/dxₙ is the same for all gas injection rates xₙ. The derivative of exponential approximation equation 6 is:

$$\frac{dy}{dx} = \frac{{ae}^{- ( \frac{x - c}{b} )}}{b} \qquad Equation 8$$

Equation 8 can be re-arranged to give:

$$x = - b ln ( \frac{b}{a} ) - b ln ( \frac{dy}{dx} ) + c \qquad Equation 9$$

With n wells equation 8 is substituted into equation 1 to give:

$$\begin{matrix}{x}_{T} = - {b}_{1} ln ( \frac{{b}_{1}}{{a}_{1}} ) - {b}_{1} ln ( \frac{dy}{dx} ) + {c}_{1} - {b}_{2} ln ( \frac{{b}_{2}}{{a}_{2}} ) - {b}_{2} ln ( \frac{dy}{dx} ) + {c}_{2} - {b}_{n} ln ( \frac{{b}_{n}}{{a}_{n}} ) - {b}_{n} ln ( \frac{dy}{dx} ) + {c}_{n} \\ {x}_{T} + {b}_{1} ln ( \frac{{b}_{1}}{{a}_{1}} ) + {b}_{2} ln ( \frac{{b}_{2}}{{a}_{2}} ) + {b}_{n} ln ( \frac{{b}_{n}}{{a}_{n}} ) - {c}_{1} - {c}_{2} - {c}_{n} = {b}_{1} ln ( \frac{dy}{dx} ) - {b}_{2} ln ( \frac{dy}{dx} ) - {b}_{n} ln ( \frac{dy}{dx} ) \\ {x}_{T} + {b}_{1} ln ( \frac{{b}_{1}}{{a}_{1}} ) + {b}_{2} ln ( \frac{{b}_{2}}{{a}_{2}} ) + {b}_{n} ln ( \frac{{b}_{n}}{{a}_{n}} ) - {c}_{1} - {c}_{2} - {c}_{n} = ln ( \frac{dy}{dx} ) ( - {b}_{1} - {b}_{2} - {b}_{n} ) \\ \frac{ \begin{matrix}{x}_{T} + {b}_{1} ln ( \frac{{b}_{1}}{{a}_{1}} ) + {b}_{2} ln ( \frac{{b}_{2}}{{a}_{2}} ) + \\ {b}_{n} ln ( \frac{{b}_{n}}{{a}_{n}} ) - {c}_{1} - {c}_{2} - {c}_{n}\end{matrix}}{( - {b}_{1} - {b}_{2} - {b}_{n} )} = ln ( \frac{dy}{dx} ) & \\ \frac{dy}{dx} = {e}^{( \frac{{x}_{T} + {b}_{1} ln ( \frac{{b}_{1}}{{a}_{1}} ) + {b}_{2} ln ( \frac{{b}_{2}}{{a}_{2}} ) + {b}_{n} ln ( \frac{{b}_{n}}{{a}_{n}} ) - ( {c}_{1} + {c}_{2} + {c}_{n} )}{- ( {b}_{1} + {b}_{2} + {b}_{n} )} )} & Equation 10\end{matrix}$$

Substituting Equation 10 into Equation 9 gives:

$${x}_{n} = - {b}_{n} ln ( \frac{{b}_{n}}{{a}_{n}} ) - {b}_{n} ( \frac{ \begin{matrix}{x}_{T} + {b}_{1} ln ( \frac{{b}_{1}}{{a}_{1}} ) + {b}_{2} ln ( \frac{{b}_{2}}{{a}_{2}} ) + \\ {b}_{n} ln ( \frac{{b}_{n}}{{a}_{n}} ) - ( {c}_{1} + {c}_{2} + {c}_{n} )\end{matrix}}{- ( {b}_{1} + {b}_{2} + {b}_{n} )} ) + {c}_{n} \qquad Equation 11$$

Equation 11 solves the optimum gas rate xₙ for an individual well for a given total amount of gas flow rate available x_{T}. Equation 11 can be transposed to a straight line Equation 12:

$$\begin{matrix}{x}_{n} = - {b}_{n} ( ln ( \frac{{b}_{n}}{{a}_{n}} ) + ( \frac{{x}_{T} + {b}_{1} ln ( \frac{{b}_{1}}{{a}_{1}} ) + {b}_{2} ln ( \frac{{b}_{2}}{{a}_{2}} ) + {b}_{n} ln ( \frac{{b}_{n}}{{a}_{n}} ) - ( {c}_{1} + {c}_{2} + {c}_{n} )}{- ( {b}_{1} + {b}_{2} + {b}_{n} )} ) ) + {c}_{n} \\ {x}_{n} = - {b}_{n} ( ln ( \frac{{b}_{n}}{{a}_{n}} ) + \frac{{x}_{T}}{- ( {b}_{1} + {b}_{2} + {b}_{n} )} + \frac{{b}_{1} ln ( \frac{{b}_{1}}{{a}_{1}} ) + {b}_{2} ln ( \frac{{b}_{2}}{{a}_{2}} ) + {b}_{n} ln ( \frac{{b}_{n}}{{a}_{n}} ) - ( {c}_{1} + {c}_{2} + {c}_{n} )}{- ( {b}_{1} + {b}_{2} + {b}_{n} )} ) + {c}_{n} \\ {x}_{n} = - {b}_{n} ln ( \frac{{b}_{n}}{{a}_{n}} ) + \frac{{b}_{n}}{( {b}_{1} + {b}_{2} + {b}_{n} )} {x}_{T} + \frac{\begin{matrix}{b}_{n} ( {b}_{1} ln ( \frac{{b}_{1}}{{a}_{1}} ) + {b}_{2} ln ( \frac{{b}_{2}}{{a}_{2}} ) + \\ {b}_{n} ln ( \frac{{b}_{n}}{{a}_{n}} ) - ( {c}_{1} + {c}_{2} + {c}_{n} ) )\end{matrix}}{( {b}_{1} + {b}_{2} + {b}_{n} )} + {c}_{n} & \\ {x}_{n} = \frac{{b}_{n}}{( {b}_{1} + {b}_{2} + {b}_{n} )} {x}_{T} + \frac{\begin{matrix}{b}_{n} ( {b}_{1} ln ( \frac{{b}_{1}}{{a}_{1}} ) + {b}_{2} ln ( \frac{{b}_{2}}{{a}_{2}} ) + \\ {b}_{n} ln ( \frac{{b}_{n}}{{a}_{n}} ) - ( {c}_{1} + {c}_{2} + {c}_{n} ) )\end{matrix}}{( {b}_{1} + {b}_{2} + {b}_{n} )} - {b}_{n} ln ( \frac{{b}_{n}}{{a}_{n}} ) + {c}_{n} & Equation 12\end{matrix}$$

Equation 12 shows that the optimum gas rate xₙ for a given total amount of gas flow rate available x_{T} can be found using straight line equation, where Sₙ (scaler) and Iₙ (intercept) are:

$$\begin{matrix} {S}_{n} = \frac{{b}_{n}}{( {b}_{1} + {b}_{2} + {b}_{3} )} & Equation 13 \\ {I}_{n} = \frac{\begin{matrix}{b}_{n} ( {b}_{1} ln ( \frac{{b}_{1}}{{a}_{1}} ) + {b}_{2} ln ( \frac{{b}_{2}}{{a}_{2}} ) + \\ {b}_{n} ln ( \frac{{b}_{n}}{{a}_{n}} ) - ( {c}_{1} + {c}_{2} + {c}_{n} ) )\end{matrix}}{( {b}_{1} + {b}_{2} + {b}_{n} )} - {b}_{n} ln ( \frac{{b}_{n}}{{a}_{n}} ) + {c}_{n} & Equation 14\end{matrix}$$

Using equation 14, with two constants per well and x_{T} the approximate optimum gas injection rate for each well can be calculated as:

xₙ=Sₙx_{T}+Iₙ Equation 15a

Therefore, in a state of equilibrium the in-flow rate x_{T} equals the total out-flow rate uₘ(t) for n gas lifted wells:

$${u}_{m} ( t ) = {K}_{mp} ( {e}_{m} ( t ) + \frac{1}{{T}_{mi}} {\int }_{0}^{t} {e}_{m} ( t ) dt + {T}_{md} \frac{{de}_{m} ( t )}{dt} ) = {x}_{T} = {S}_{1} {x}_{T} + {I}_{1} + {S}_{2} {x}_{T} + {I}_{2} … + {S}_{n} {x}_{T} + {I}_{n}$$

The master pressure controller 23 is arranged in operative communication with a controller apparatus 27, which may be located remotely from the system 20. The controller apparatus 27 may include a programmable electronic processor. The controller apparatus 27 determines and sets an individual out flow rate x₁, x₂, . . . xₙ at each variable position flow control valve 5 in accordance with the output rate uₘ(t) of the master pressure controller 23 using the formula:

xₙ=Sₙx_{T}+Iₙ

wherein

uₘ(t)=x_{T}

Thus, the invention utilises the master pressure controller 23 of which the output value uₘ(t) represents the total amount of gas available for injection to the gas-lifted wells. The pressure controller output value uₘ(t) is used by the controller apparatus 27 in real time calculation to determine the optimum gas injection flow rate x₁, x₂, . . . xₙ to each well. The calculation uses pre-set values which represent an exponential curve approximation of the productivity curve of each gas lifted well.

Because the individual desired gas injection flow rates xₙ can be calculated with simple operators, the calculation can be executed within a modern control system without long execution times. The present invention proposes calculating these desired gas injection flow rates in real time for each well using the equations above. These values are passed as variable remote set-points (RSP's) for each associated well gas injection flow controller 7.

The system 20 continuously adjusts all flows by means of the flow controller 7 adjusting the respective variable position flow control valves 5 for all wells for any amount of gas available. This has the effect of producing more oil and more gas to be reinjected. Over a period of gas recirculation the total flow will increase to a new equilibrium.

If the process suffers a decrease in available flow to gas compressor 1 due to a process disturbance, the flow into the injection manifold 3 will decrease and therefore the pressure will decrease. With the proposed invention the pressure controller 23 causes an automatic reduction of the remote set-points of the flow controller 7 and therefore the position of the respective flow control valves 5 in an optimum manner to control the injection manifold pressure. This ensures that the injection manifold pressure does not decrease to a point where the compressors 1 trip on low discharge pressure. The system 20 can therefore remain in automatic control in continuous normal operation.

The overall effect of the proposed invention is increased production from gas-lifted wells.

The invention is defined in the appended claims. Modifications and variations are possible within the scope of the appended claims.

1. A system (20) for controlling gas flow allocation to gas-lifted wells, the system comprising:
a gas lift manifold (3) for receiving pressurised gas at an in-flow rate x_{T}, the gas lift manifold (3) being in fluid communication with n continuous gas lifted wells via respective flow control valves (5) to distribute the gas to each well at individual out flow rates x₁, x₂, . . . xₙ through each flow control valve (5) wherein in a state of equilibrium the in-flow rate x_{T} equals the sum of the individual out flow rates:
x_{T}=x₁+x₂ . . . +xₙ
and
wherein the system (20) comprises a controller apparatus (27) in operative communication with the flow control valves (5), the controller apparatus being configured to determine and set an individual out flow rate x₁, x₂, . . . xₙ at each respective flow control valve (5) for a given total amount of the available in-flow rate x_{T} in accordance with the formula:
$${x}_{n} = {S}_{n} {x}_{T} + {I}_{n}$$
$$wherein$$
$${S}_{n} = \frac{{b}_{n}}{( {b}_{1} + {b}_{2} + {b}_{n} )}$$
$$wherein$$
$${I}_{n} = \frac{{b}_{n} ( {b}_{1} ln ( \frac{{b}_{1}}{{a}_{1}} ) + {b}_{2} ln ( \frac{{b}_{2}}{{a}_{2}} ) + {b}_{n} ln ( \frac{{b}_{n}}{{a}_{n}} ) - ( {c}_{1} + {c}_{2} + {c}_{n} ) )}{( {b}_{1} + {b}_{2} + {b}_{n} )} - {b}_{n} ln ( \frac{{b}_{n}}{{a}_{n}} ) + {c}_{n}$$
wherein
a is the maximum production flow rate from the respective well;
b is defined as one fifth of the associated individual gas injection rate in the respective well at which peak production flow is achieved;
c is individual gas injection rate required in the respective well before production flow starts in the well.

2. A system of claim 1, wherein c is assumed to be zero.

3. A system of claim 1, wherein the gas lift manifold (3) includes a master pressure controller (23) upstream of the flow control valves (5), the master pressure controller (23) being in operative communication with the controller apparatus (27), and the master pressure controller (23) operating at an output rate uₘ(t) wherein the output rate uₘ(t) of the master pressure controller (23) is equal to the total in-flow rate x_{T} in a state of equilibrium:
uₘ(t)=x_{T}

4. A system of claim 3, wherein the controller apparatus (27) is configured to determine and set an individual out flow rate x₁, x₂, . . . xₙ at each flow control valve (5) in accordance with the output rate uₘ(t) of the master pressure controller (23).

5. A system of claim 3, wherein the master pressure controller (23) operates at a gas injection manifold pressure value Pₘₐₙ equal to the master pressure controller (23) set-point r.

6. A system of claim 1, wherein the controller apparatus (27) is adapted to operate in real time.

7. A system of claim 1, wherein the controller apparatus (27) comprises a programmable electronic processor.

8. A system of claim 3, wherein the controller apparatus (27) is located remotely from the master pressure controller (23) and the flow control valves (5).

9. A system of claim 1 wherein the system (20) is a reinjection system in which gas produced from the wells is reinjected into the gas lift manifold (3) for use in gas lifting.

10. A system of claim 1, wherein the controller apparatus (27) is adapted to continuously adjust all flows through the respective flow control valves (5) for all wells for any amount of gas available.

11. A method for controlling gas flow allocation to gas-lifted wells, the method comprising:
delivering pressurised gas into a gas lift manifold (3) at an in-flow rate x_{T}, the gas lift manifold (3) being in fluid communication with n continuous gas lifted wells via respective flow control valves (5);
distributing the gas to each well at individual out flow rates x₁, x₂, . . . xₙ through each respective flow control valve (5) wherein in a state of equilibrium the in-flow rate x_{T} equals the sum of the individual out flow rates:
x_{T}=x₁+x₂ . . . +xₙ;
and
determining and setting an individual out flow rate x₁, x₂, . . . xₙ at each respective flow control valve (5) for a given total amount of the available in-flow rate x_{T} in accordance with the formula:
$${x}_{n} = {S}_{n} {x}_{T} + {I}_{n}$$
$$wherein$$
$${S}_{n} = \frac{{b}_{n}}{( {b}_{1} + {b}_{2} + {b}_{n} )}$$
$$wherein$$
$${I}_{n} = \frac{{b}_{n} ( {b}_{1} ln ( \frac{{b}_{1}}{{a}_{1}} ) + {b}_{2} ln ( \frac{{b}_{2}}{{a}_{2}} ) + {b}_{n} ln ( \frac{{b}_{n}}{{a}_{n}} ) - ( {c}_{1} + {c}_{2} + {c}_{n} ) )}{( {b}_{1} + {b}_{2} + {b}_{n} )} - {b}_{n} ln ( \frac{{b}_{n}}{{a}_{n}} ) + {c}_{n}$$
wherein
a is the maximum production flow rate from the respective well;
b is defined as one fifth of the associated individual gas injection rate in the respective well at which peak production flow is achieved;
c is individual gas injection rate required in the respective well before production flow starts in the well.

12. A method of claim 11, wherein the method comprises providing a controller apparatus (27) in operative communication with the flow control valves (5) and using the controller apparatus (27) to determine and set an individual out flow rate x₁, x₂, . . . xₙ at each respective flow control valve (5) for a given total amount of the available in-flow rate x_{T} in accordance with the formula:
xₙ=Sₙx_{T}+Iₙ

13. A method of claim 11, wherein the method includes assuming c to be zero.

14. A method of claim 12, wherein the method comprises the step of controlling gas pressure in the gas lift manifold (3) by a master pressure controller (23) provided upstream of the flow control valves (5), the master pressure controller (23) being in operative communication with the controller apparatus (27) and the master pressure controller (23) operating at an output rate uₘ(t) wherein the output rate uₘ(t) of the master pressure controller (23) is equal to the total in-flow rate x_{T} in a state of equilibrium:
uₘ(t)=x_{T}

15. A method of claim 14, wherein the method comprises the step of determining and setting an individual out flow rate x₁, x₂, . . . xₙ at each flow control valve (5) in accordance with the output rate uₘ (t) of the master pressure controller (23).

16. A method of claim 14, wherein the method includes operating the master pressure controller (23) at a gas lift manifold (3) pressure value Pₘₐₙ equal to the master pressure controller (23) set-point t.

17. A method of claim 11, wherein the method comprises the step of determining and setting an individual out flow rate x₁, x₂, . . . xₙ at each respective flow control valve (5) in real time.

18. A method of claim 12, wherein the method includes the step of providing the controller apparatus (27) remote from the master pressure controller (23) and the flow control valves (5).

19. A method of claim 11, wherein the method includes reinjecting gas produced from the wells into the gas lift manifold (3) for use in gas lifting.

20. A method of claim 11, wherein the method comprises continuously adjusting all flows through the respective flow control valves (5) for all wells for any amount of gas available.
